(19) United States
(12) Patent Application Publication
(10) Pub. No.: US 2004/0111386 A1
(43) Pub. Date: Jun. 10, 2004

(54) Knowledge neighborhoods

(76) Inventors: Jonathan M. Goldberg, San Francisco, CA (US); David L. Gilmour, Los Altos Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/754,385

(22) Filed: Jan. 8, 2001

(51) Int. Cl. G06F 7/00

(52) U.S. Cl. 707/1

(57) ABSTRACT

Knowledge neighborhoods are generated from concepts associated with knowledge profiles within an organization to create a knowledge taxonomy. A root concept is used to select a set of profiles associated with the root concept. At least one concept common to the set of profiles is determined and an affinity between the common concept and the root concept is derived. The common concept is a knowledge neighbor of the root concept. A set of one or more such knowledge neighbors forms one level of the knowledge neighborhood for the root concept. The knowledge neighborhood can grow through various levels by using one or more of the common concepts as a new root concept. A knowledge map can be employed to graphically illustrate the knowledge neighborhood.

### FIELD OF THE INVENTION

This invention relates generally to the field of knowledge management and more particularly to creating knowledge neighborhoods that represent knowledge taxonomies.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 1999, Tacit Knowledge Systems, Inc., All Rights Reserved.

### BACKGROUND OF THE INVENTION

The new field of “knowledge management” (KM) is receiving increasing recognition as the gains to be realized from the systematic effort to store and export vast knowledge resources held by employees of an organization are being recognized. The sharing of knowledge broadly within an organization offers numerous potential benefits to an organization through the awareness and reuse of existing knowledge, and the avoidance of duplicate efforts.

In order to maximize the exploitation of knowledge resources within an organization, a knowledge management system may be presented with two primary challenges, namely (1) the identification of knowledge resources within the organization and (2) the distribution and accessing of information regarding such knowledge resources within the organization.

The identification, capture, organization and storage of knowledge resources is a particularly taxing problem. Prior art knowledge management systems have typically implemented knowledge repositories that require users manually to input information frequently into pre-defined fields, and in this way manually and in a prompted manner to reveal their personal knowledge base. However, this approach suffers from a number of drawbacks in that the manual entering of such information is time consuming and often incomplete, and therefore places a burden on users who then experience the inconvenience and cost of a corporate knowledge management initiative long before any direct benefit is experienced. Furthermore, users may not be motivated to describe their own knowledge and to contribute documents on an ongoing basis that would subsequently be re-used by others without their awareness or consent. The manual input of such information places a burden on users who then experience the inconvenience and cost of a corporate knowledge management initiative long before any direct benefit is experienced.

The presentation of the captured knowledge information has also been problematic. The creation of knowledge taxonomies that allow an organization to gauge the scope and clustering of the knowledge of its employees is a manual process that cannot readily and quickly adjust to changes in the knowledge information.

It has been the experience of many corporations that knowledge management systems, after some initial success, may fail because either compliance (i.e., the thoroughness and continuity with which each user contributes knowledge) or participation (i.e., the percentage of users actively contributing to the knowledge management system) falls to inadequate levels. Without high compliance and participation, it becomes a practical impossibility to maintain a sufficiently current and complete inventory of the knowledge of all users. Under these circumstances, the knowledge management effort may never offer an attractive relationship of benefits to costs for the organization as a whole, reach a critical mass, and the original benefit of knowledge management falls apart or is marginalized to a small group.

In order to address the problems associated with the manual input of knowledge information, more sophisticated prior art knowledge management initiatives may presume the existence of a centralized staff to work with users to capture knowledge bases. This may however increase the ongoing cost of knowledge management and requires a larger up-front investment before any visible payoff, thus deterring the initial funding of many an otherwise promising knowledge management initiatives. Even if an initial decision is made to proceed with such a sophisticated knowledge management initiative, the cash expenses associated with a large centralized knowledge capture staff may be liable to come under attack, given the difficulty of quantifying knowledge management benefits in dollar terms.

As alluded to above, even once a satisfactory knowledge management information base has been established, the practical utilization thereof to achieve maximum potential benefit may be challenging. Specifically, ensuring that the captured information is readily organized, available, and accessible as appropriate throughout the organization may be problematic.

### SUMMARY OF THE INVENTION

Knowledge neighborhoods are generated from concepts associated with knowledge profiles within an organization to create a knowledge taxonomy. A root concept is used to select a set of profiles associated with the root concept. At least one concept common to the set of profiles is determined and an affinity between the common concept and the root concept is derived. The common concept is a knowledge neighbor of the root concept. A set of one or more such knowledge neighbors forms one level of the knowledge neighborhood for the root concept. The knowledge neighborhood can grow through various levels by using one or more of the common concepts as a new root concept. A knowledge map can be employed to graphically illustrate the knowledge neighborhood.

In one aspect, only those common concepts that satisfy a confidence level threshold are considered knowledge neighbors of the root concept. In another aspect, only those knowledge profiles associated with the root concept at a confidence level that satisfies a threshold are selected for the set of profiles from which the knowledge neighbors of the root concept are determined.

Because the knowledge neighbors to a concept are the related concepts as represented by knowledge terms within the profiles and not the profiles that contain the related concepts, or the individuals that own the profiles containing the related concepts, the present invention creates an abstraction of the knowledge, and the relationship among the various types of knowledge, within the organization. The presentation of the knowledge neighborhoods through the knowledge map allows domain experts within an organization to see islands and groupings of concepts to more easily understand the knowledge underlying the organization.

The present invention describes systems, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a block diagram illustrating a knowledge management system, according to an exemplary embodiment of the present invention.

FIG. 2 is a block diagram illustrating a knowledge neighborhood and its creation according to one embodiment of the invention.

FIG. 3 is a flow chart illustrating a method for creating a knowledge neighborhood.

FIG. 4 is a diagram of one embodiment of a computer system suitable for performing any one of the methods discussed above.

### DETAILED DESCRIPTION OF THE INVENTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

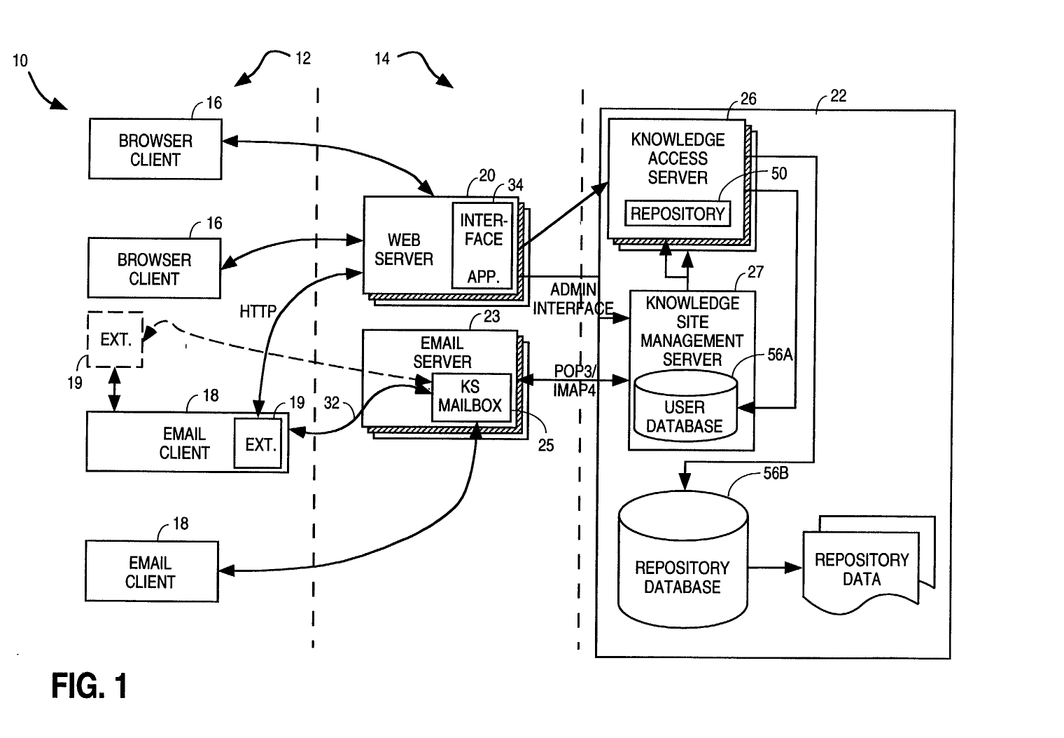

FIG. 1 is a block diagram illustrating an exemplary embodiment of a knowledge management system 10 that intercepts electronic documents, extracts terms therefrom that are potentially indicative of a knowledge base of a user, and distributes a user knowledge profile constructed from the extracted “knowledge” terms. For the purposes of the present application, the word “term” and phrase “knowledge term” shall be taken to include any acronym, word, collection of words, phrase, sentence, or paragraph.

The grammatical structure, length, frequency and density with which the extracted knowledge terms occur within the electronic documents, and prior history of use of the extracted knowledge terms within an organization may furthermore be utilized to attach a metric, in the form of a confidence level value, to the relevant knowledge terms for the purpose of grouping, ranking, and prioritizing such knowledge terms. For the purposes of the present application, the term “confidence level” shall be taken to mean any indication, numeric or otherwise, of a level within a predetermined range.

Knowledge terms may furthermore be stored in either a private or public portion of the user knowledge profile, depending upon the confidence level values thereof. With a view to determining which terms are truly indicative of a knowledge base, a number of rules (or algorithms) may be exercised with respect to extracted terms to identify terms that are candidates for inclusion within a public portion of the user knowledge profile. Further rules (or algorithms) may be applied to an assembled knowledge profile for the purpose of continually organizing and refining the profile. Alternatively, the contents of a user's knowledge profile may be periodically reviewed by the user (“owner”) to organize the public and private portions according to user preferences.

User control over the content of the private and public portions of the user's knowledge profile enhance the privacy of the system, protecting electronic documents from unwanted intrusion by others, including searchers. Unrestricted access to the public portion of the user knowledge profile may be provided to other users, for instance those in a particular organization. The private portion of a user knowledge profile may, on the other hand, have a restricted access and may require specific authorization by the owner for the provision of information concerning the user knowledge profile, and the owner, in response to a specific request.

The knowledge management system 10 may conveniently be viewed as comprising a client system 12 and a server system 14. Client system 12 includes clients with access to the server system 14, such as Internet browser clients 16 or e-mail clients 18, which may be resident on machines within the knowledge management system 10 or coupled to it through a computer network. Extensions 19 are incorporated into an e-mail client 18 to enable it to send electronic messages to a knowledge server 22. In particular, e-mail messages are copied to a special e-mail address 25 maintained by an e-mail server 23 that is associated with the knowledge server 22 (illustrated as arrow 32). As shown in FIG. 1, the extensions 19 may be integral with an e-mail client 18, or external to the client 18 and in communication therewith. Alternatively, the user of an e-mail client 18 may manually address an email to the e-mail address 25, or e-mails from the client system 12 may be intercepted by the first server through which the e-mails pass and forwarded onto the knowledge server 22, thus eliminating the need for the extensions 19. The browser clients 16 provide an additional means to submit documents to the knowledge server 22 through an interface application 34 maintained on a web server 20.

The server system 14 of the system 10 includes the web server 20, the e-mail server 23 and the knowledge server 22, although the invention is not so limited. The components of the knowledge server 22 illustrated in FIG. 1 are collectively responsible for examining and processing electronic documents received on the server system 14 from various sources, including the email server 23 and the web server 20. Servers for other text-based applications used in the organization also may be considered part of the server system 14 and are interfaced into the knowledge server 22 through gateways (not shown). It will be further appreciated that alternate means of submitting electronic documents to the knowledge server 22, such as the implementation of standard application program interfaces (APIs), are contemplated as within the scope of the invention.

The knowledge server 22 includes a knowledge site management server (KSMS) 27 and a knowledge access server (KAS) 26. The KAS 26 provides a local, logical view of a knowledge repository 50, which is physically stored in a user database 56A and a repository database 56B. Once extracted from the electronic documents, knowledge terms may be processed so as to associate them with other knowledge terms within the repository 50 and to create or update knowledge profiles. Both databases 56A, 56B may store knowledge terms, as well as other data pertaining to users, the system, passwords, etc., in codes or other encrypted form that are only meaningful when accessed through the interfaces offered by system 10 to enhance privacy. The KSMS 27 is given access to the local view of the knowledge repository 50 maintained by the KAS 26. It will be appreciated that although the user database 56A and the repository database 56B are illustrated as separate databases in FIG. 1, other physical and/or logical arrangements of the databases 56A, 56B and the corresponding knowledge repository 50 are equally applicable to the present invention.

The web server 20 facilitates access to the local view of the knowledge repository 50 by the browser clients 16 through the web server interface application 34. The web server 20 also facilitates knowledge profile queries, e-mail addressing based on knowledge profiles, and other types of access to the knowledge server 22.

Further details of the knowledge management system 10 and the creation and use of knowledge profiles are given in U.S. Pat. No. 6,115,709 entitled METHOD AND SYSTEM FOR CONSTRUCTING A KNOWLEDGE PROFILE OF A USER HAVING UNRESTRICTED AND RESTRICTED ACCESS PORTIONS ACCORDING TO LEVELS OF CONFIDENCE OF THE CONTENT OF THE PORTIONS, issued on Sep. 5, 2000 and assigned to the assignee of the present application, and which is hereby incorporated by reference.

Knowledge neighborhoods represent an high-level taxonomy of the knowledge within an organization. The taxonomy is generated from the knowledge profiles maintained within an organization, either public profiles, private profiles, or both. A knowledge neighbor is a concept that is deemed related to another concept because the concepts occur together within profiles.

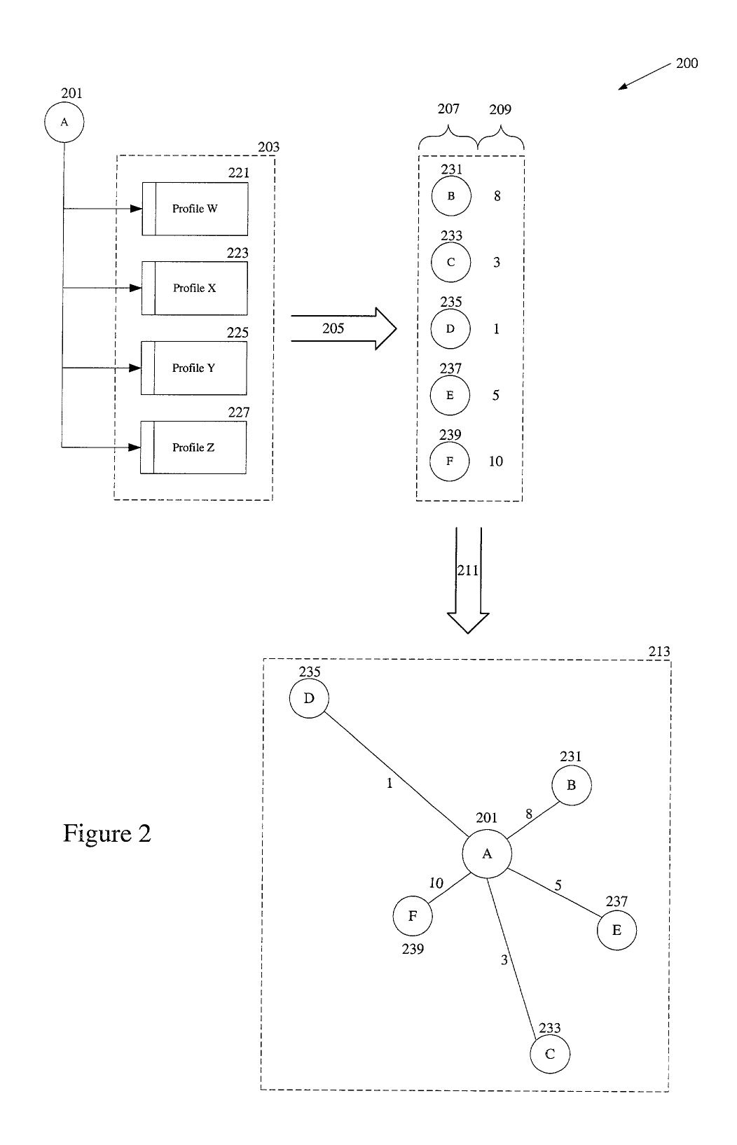

Turning now to FIG. 2, one embodiment of the generation and display of a first level of a knowledge neighborhood is described. A root concept A 201 is selected as a starting point from which a knowledge neighborhood will grow. A set of knowledge profiles 203 that contain the root concept A 201 is selected. In the simplest case, the root concept A 201 is a single word knowledge term but it will be appreciated that the root concept can be any parameter that can be used to select a set of knowledge profiles, including a multi-word knowledge term, a profile, a search criteria, or a document, etc. All profiles containing the root concept may be selected, or only those profiles in which the root concept has a high confidence level as specified by a threshold value. In FIG. 2, four profiles, profile W 221, profile X 223, profile Y 225, and profiles Z 237 all contain the root concept A 201.

The selected profiles 203 are evaluated to discover concepts represented by knowledge terms within the profiles 203 that are common to the profiles 203 (arrow 205). Further filtering of the common concepts 207 based on their confidence level may also be performed so that the resulting concepts 207 are the high confidence knowledge neighbors of the root concept A 201. The common concepts 207 define a first level of knowledge neighborhoods centered on the root concept A 201. The common concepts are represented in FIG. 2 by concept B 231, concept C 233, concept D 2355, concept E 237, and concept F 239.

Each of the common concepts 207 is assigned an affinity 209 that represents the distribution of the common concepts 207 in relationship to the root concept A 201 within the profiles 203. In the embodiment illustrated in FIG. 2, an affinity 209 represents the highest affinity while zero means there is no affinity, i.e., concepts that do not appear together in any profile have an affinity of zero. The affinity 209 is derived from the number of profiles 203 containing the common concept 207 and the confidence value of the common concept 207 within each profile 203. One formula suitable for deriving the affinity is given below.

The common concepts 207 and their associated affinities 209 are used to create (arrow 211) a knowledge map 213 that illustrates the first level of knowledge neighborhoods. The knowledge map is a graphical display of the affinity between the knowledge neighbors of the root concept A 201. In the present embodiment, the knowledge map is a directed graph with edges radiating out from a node for the root concept A 201 to represent the relationships between each of the common concepts 207 and the root concept A 201. The length of the edge between the root concept A 201 node and a common concept 207 node is proportional to the affinity 209. Thus, for example the affinity between the root concept A 201 and the common concept F 239 is high (an affinity of 10) and therefore the edge between the nodes for the two concepts is short. In contrast, the affinity between the root concept A 201 and the common concept D 235 is low (1) and so the edge between the two nodes for the concepts is long.

If additional levels of knowledge neighborhoods are desired, the invention is applied recursively against one or more of the common concepts 207. In one embodiment, this is accomplished by the user selecting one of the common concept nodes shown on the knowledge map to serve as the new root concept but the invention is not so limited.

As previously described, the affinity for a common concept is derived from the confidence levels of the common concept in the selected profiles. In an exemplary embodiment, the affinity is calculated as the sum, over all the selected profiles N in which the common concept C appears, of the product of the confidence level of the root concept L(R) and the confidence level of the common concept L(C) in each profile P:

$${\sum }_{P = 1}^{N} {L ( R )}_{P} * {L ( C )}_{P} . \qquad ( formula 1 )$$

Referring to the elements shown in FIG. 2 as an example, assume that the root concept A 201 appears in profile W 221 at a confidence level of 100, i.e., L(A)_{W}=100, in profile X 223 at a confidence level of 50, i.e., L(A)_{X}=50, and in profile Y 225 at a confidence level of 200, i.e., L(A)_{Y}=200. Also assume that concept B 231 appears in profile W 221 at a confidence level of 150, i.e., L(B)_{W}=150, and in profile Y 225 at a confidence level of 50, i.e., L(B)_{Y}=50. Therefore, the affinity of concept B 231 in this example is (L(A)_{W}*L(B)_{W}) +(L(A)_{Y}*L(B)_{Y}) or (100*150)+(200*50). Further assume that concept C 233 appears in profile X 223 at a confidence level of 200, i.e., L(C)_{X}=200, and in profile Y 225 at a confidence level of 100, i.e., L(C)_{Y}=100. Therefore, the affinity of concept C 233 in this example is (L(A)_{X}*L(C)_{X})+(L(A)_{Y}*L(C)_{Y}) or (50*200)+(200*100).

It will be appreciated that other statistical methodologies such as averaging, weighting, scaling, etc., may be used to calculate the affinity in place of, or in conjunction with, formula 1 above. It further will be appreciated that the affinity between the concepts is independent of the usage of words within the concepts, i.e., their lexical relationships, or any predefined taxonomies, or organizational domains.

The profiles that are searched to find the root concept can be aggregated or segregated to generate knowledge neighborhoods of particular portions of an organization. Additionally, an organization might decide that certain knowledge within the organization is private to the organization vis-a-vis third-parties but public for the purpose of generating knowledge neighborhoods.

Because the knowledge profiles are dynamic, the knowledge neighborhoods are dynamic. Therefore, if a particular knowledge neighborhood at a particular period of time is saved or cached, subsequent knowledge neighborhoods can be overlaid and compared so that the change in the focus of the knowledge in the organization over time can be determined by looking at the change in affinity among the concepts. In such a comparison mode, the resulting knowledge maps can be played over time to obtain an animated view of the change of focus of an organization.

Furthermore, a merge mode may also be used to make an existing knowledge map more intelligible to domain experts by translating the nodes into terminology most appropriate for a particular domain. In merge mode, concept nodes are labeled using terminology from an externally created domain knowledge taxonomy. Such a taxonomy already organizes knowledge concepts into named, identified nodes. The present invention would match a knowledge neighbor to one or more of these taxonomy nodes and label the knowledge map using the names from the taxonomy. For example, assume the taxonomy has a node called “Distributed Object Computing” including keywords “CORBA” and “DCE.” A node in the knowledge map that contains the knowledge term “CORBA” would be labeled “Distributed Object Computing” as a result of searching the taxonomy.

The abstraction level provided by the knowledge neighborhoods of the present invention yields multiple advantages to domain experts. For example, the information that several people know different relational database systems, and thus those concepts within their profiles are probably knowledge neighbors, can be derived using other techniques. However, the information that the concepts of music and computer programming are knowledge neighbors is probably not readily available from other sources. Thus, the invention can answer a more abstract question such as “What other concepts are important to people who know about computer programming?” where other techniques can only pinpoint particular individuals that understand computer programming.

The knowledge mapping of the present invention allows the domain experts within an organization to see islands and groupings of concepts within the organization. For example, the chief knowledge officer (CKO) of company needs to know what the company knows. Just seeing the list of the information is not particularly helpful. Instead, the CKO needs to see the organization of the knowledge within the company, i.e., people who focus on engineering also know X and Y, or the people who focus on human resources also know about Z. This allows the CKO to determine if the company, or portions of the company is focusing on something that it should not.

For purposes of generating a knowledge neighborhood, the neighbors are the related concepts represented by knowledge terms within the profiles and not the profiles that contain the related concepts, or the individuals that own the profiles containing the related concepts. However, the present invention can also expose knowledge that may not have been fully utilized previously. By maintaining references from the concepts to the profiles in which they appear, the knowledge neighborhoods can be related to individual profiles or aggregates of profiles. Using this embodiment, one can easily determine the number of people who cluster around particular concepts and determine if enough people are focusing on the important concepts of the organization. Additional information can be gained by subsequently identifying the owners of the individual profiles. When such information is made available within the knowledge map, the viewer may be able to “drill down” from the graphical representation of a concept to the underlying profiles and eventually the owners having knowledge of the concept.

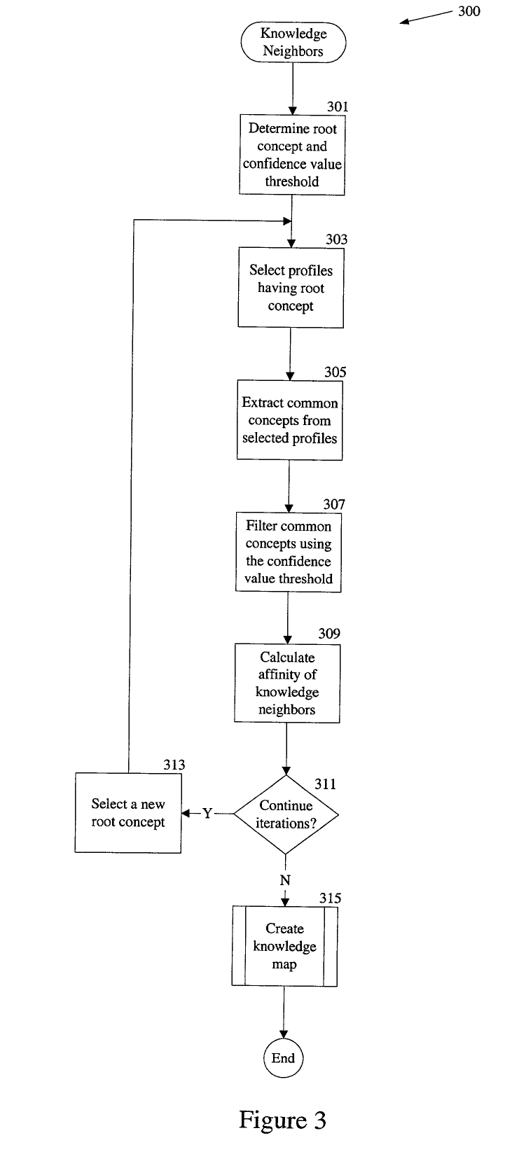

Next, one embodiment of a method that generates knowledge neighborhoods in accordance with the present invention is described in terms of computer software with reference to a flowchart in FIG. 3. The methods constitute computer programs made up of computer-executable instructions illustrated as blocks (acts) 301 until 315. Describing the methods by reference to a flowchart enables one skilled in the art to develop such programs including such instructions to carry out the methods on suitably configured computers (the processor of the computer executing the instructions from computer-readable media, such as the KSMS 27 or KAS 26 or any other server with access to the knowledge profiles of an organization.

The root concept and a confidence level threshold for the knowledge neighbors of the root concept is determined, such as through user input or default values (block 301). The profiles that contain the root concept are selected (block 303) and then examined to extract the common concepts (block 305). The common concepts found in the selected profiles are filtered by confidence value against the confidence level threshold (block 307). Each of common concepts that meet or exceed the threshold is considered a knowledge neighbor of the root concept. An affinity vis-a-vis the root concept for each of the knowledge neighbors is calculated (block 309). At this point, the set of knowledge neighbors form a first level of the knowledge neighborhood for the root concept. Additional levels of the knowledge neighborhood may be obtained by iterating through the process represented by blocks 303 until 309. If additional levels are desired (block 311), one of the knowledge neighbors is selected to be a new root concept (block 313) and the method returns to block 303 to select a new set of profiles. It will be appreciated that operations represented by blocks 303 until 309 may be performed on all of the knowledge neighbors at one level to build that level of a knowledge neighborhood before building subsequent levels, or on a single knowledge neighbor at one level and then on a single knowledge neighbor at each of the subsequent levels, or on multiple knowledge neighbors on various levels. Moreover, one of skill in the art will readily understand that the decision to continue iterations at block 311 and the selection of new root concept at block 313 may be determined by user interaction, or may be parameter or algorithmically driven.

Once all the desired levels of knowledge neighborhoods have been calculated, the knowledge map is created (block 315). The knowledge map is created using conventional graphing methodologies that can illustrate, in some fashion, the affinity between the root concept and the neighboring concepts. As previously described, a directed graph is one such methodology but the use of color, intensity, or other visual signals instead of, or in addition to, graph edges are also contemplated as within the scope of the invention. Additionally, the concepts do not have to be illustrated as lodes within clusters of node. It will further be appreciated that the knowledge map can also be created as each level of the knowledge neighborhoods is defined instead of waiting until all the levels are defined. In particular, when the knowledge map is presented at each level, it may be interactive to allow the viewer to select the node to be used as the root concept for the next iteration. If no choice is made, the method 300 terminates.

One of skill in the art will readily appreciate that the invention is not limited by the processes and processing order illustrated in FIG. 3, and that the processes represented by the blocks can be combined, separated, eliminated or supplemented without exceeding the scope of the invention. For example, in an alternate embodiment, a confidence level threshold is employed at block 303 to initially filter the selected profiles based on the confidence level of the root concept within all profiles containing the root concept.

In still another alternate embodiment, no filtering of the common concepts is performed, eliminating the process represented by block 307. Therefore, all common concepts are considered knowledge neighbors of the root concept so affinities for all the common concepts are calculated at block 309. Subsequently, at block 315, a confidence level threshold is obtained, e.g., from the viewer, and the knowledge map shows only those knowledge neighbors that satisfy the threshold. By repeatedly using different confidence level thresholds, the knowledge neighborhood of the root concept expands and contracts. Similarly, yet another alternate embodiment obtains an affinity threshold at block 315 and the knowledge map shows only the knowledge neighbors that satisfy the affinity threshold.

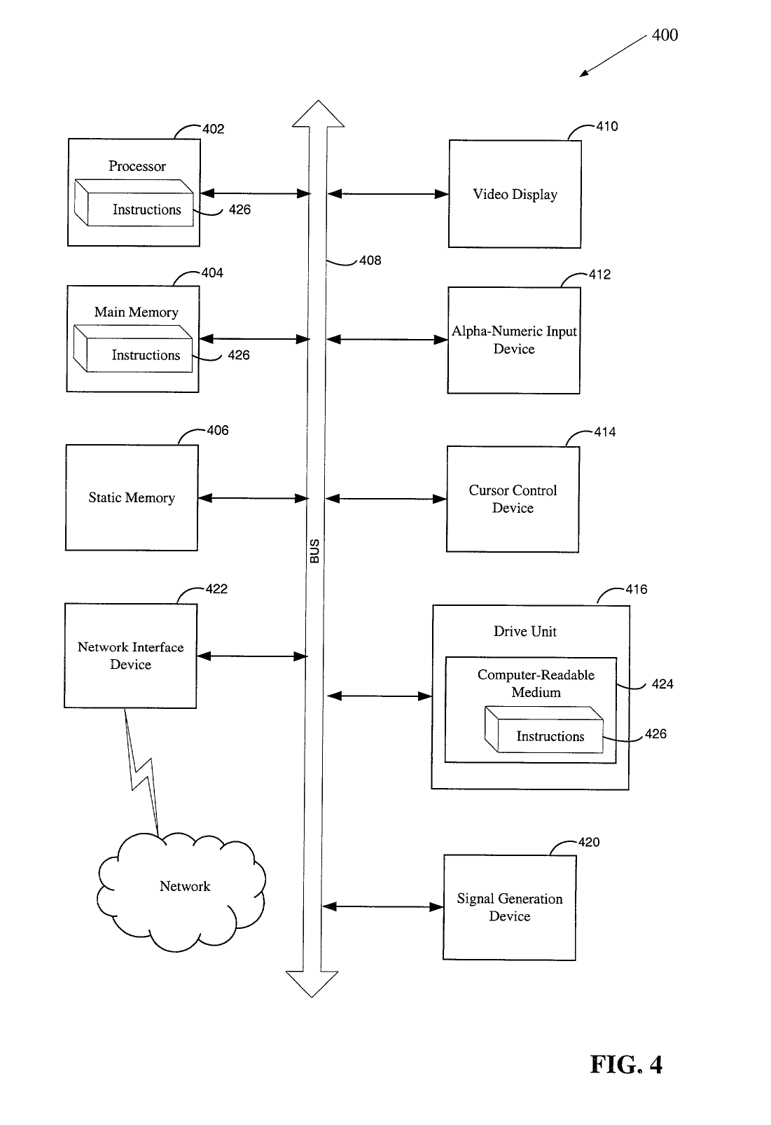

FIG. 4 is a diagrammatic representation of a machine in the form of computer system 400 within which software, in the form of a series of machine-readable instructions, for performing any one of the methods discussed above may be executed. The computer system 400 includes a processor 402, a main memory 403 and a static memory 404, which communicate via a bus 406. The computer system 400 is further shown to include a video display unit 408 (e.g., a liquid crystal display (LCD) or a cathode ray tube (CRT)). The computer system 400 also includes an alphanumeric input device 410 (e.g., a keyboard), a cursor control device 412 (e.g., a mouse), a disk drive unit 414, a signal generation device 416 (e.g., a speaker) and a network interface device 418. The disk drive unit 414 accommodates a machine-readable medium 415 on which software 420 embodying any one of the methods described above is stored. The software 420 is shown to also reside, completely or at least partially, within the main memory 403 and/or within the processor 402. The software 420 may furthermore be transmitted or received by the network interface device 418. For the purposes of the present specification, the term “machine-readable medium” shall be taken to include any medium that is capable of storing or encoding a sequence of instructions for execution by a machine, such as the computer system 400, and that causes the machine to perform the methods of the present invention. The term “machine-readable medium” shall be taken to include, but not be limited to, solid-state memories, optical and magnetic disks, and carrier wave signals.

If written in a programming language conforming to a recognized standard, the software 420 can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a machine, such as the computer system 400, the machine to perform an action or produce a result.

The preceding description of FIG. 4 is intended to provide an overview of computer hardware and other operating components suitable for implementing the invention, but is not intended to limit the applicable environments. One of skill in the art will immediately appreciate that the invention can be practiced with computer architectures and configurations other than that shown in FIG. 4, including hand-held devices, multiprocessor systems, microprocessor-based or programmable consumer electronics, network PCs, minicomputers, mainframe computers, and the like. A typical computer system will usually include at least a processor, memory, and a bus coupling the memory to the processor. The invention can also be practiced in distributed computing environments where tasks are performed by remote processing devices that are linked through a communications network.

Knowledge neighborhood generated from concepts associated with knowledge profiles has been described. A root concept is used to determine a set of profiles associated with the root concept. Concepts common to the set of profiles define the knowledge neighbors of the root concept. The knowledge neighborhood can grow through various levels by using one or more of the common concepts as a new root concept. A knowledge map can be employed to graphically illustrate the various levels of the knowledge neighborhood.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

For example, those of ordinary skill within the art will appreciate that the various thresholds described above may represent either a maximum or minimum value, and that such thresholds may be input by a user or pre-defined. Furthermore, those of ordinary skill within the art will appreciate that the knowledge map of the knowledge neighborhoods is not limited to illustrate a knowledge taxonomy but can also be used to graphically display the results of a search on a particular knowledge concept. Therefore, it is manifestly intended that this invention be limited only by the following claims and equivalents thereof.

What is claimed is:

1. A method of generating a knowledge neighborhood comprising:
selecting a set of knowledge profiles associated with a root concept;
determining a knowledge neighbor for the root concept, the knowledge neighbor being a concept common to the selected knowledge profiles; and
deriving an affinity for the knowledge neighbor to represent a relationship between the root concept and the knowledge neighbor.

2. The method of claim 1 further comprising:
using the knowledge neighbor as a new root concept to determine an additional knowledge neighbor.

3. The method of claim 1, wherein determining a knowledge neighbor comprises:
filtering all concepts common to the selected knowledge profiles against a pre-determined confidence level threshold.

4. The method of claim 1, wherein selecting the set of knowledge profiles comprises:
filtering all knowledge profiles associated with the root concept against a pre-determined confidence level threshold.

5. The method of claim 1 further comprising:
obtaining an identity for the root concept.

6. The method of claim 1, wherein obtaining the identity for the root concept comprises:
receiving a user selection of the root concept.

7. The method of claim 1, wherein the root concept is selected from the group consisting of a knowledge term, a profile, a search criteria, and a document.

8. The method of claim 1 further comprising:
creating a knowledge map to graphically illustrate the root concept, the knowledge neighbor, and the affinity.

9. The method of claim 8 further comprising:
using the knowledge map to designate the knowledge neighbor as a new root concept to determine an additional knowledge neighbor.

10. The method of claim 8 further comprising:
overlaying the knowledge map on an earlier generated knowledge map.

11. The method of claim 8 further comprising:
graphically illustrating more than one knowledge neighbor as a single knowledge neighbor.

12. The method of claim 8, wherein creating the knowledge map comprises:
graphically illustrating the knowledge neighbor if it satisfies an affinity threshold.

13. The method of claim 8, wherein the knowledge map is a directed graph comprising:
a node representing the root concept;
a node representing the knowledge neighbor; and
an edge representing the affinity, the edge graphically linking the node representing the root concept and the node representing the knowledge neighbor.

14. The method of claim 13, wherein the edge is illustrated with a length proportional to the affinity.

15. The method of claim 13, wherein the edge is illustrated with a color assigned to the affinity.

16. The method of claim 1, wherein deriving the affinity comprises:
counting the knowledge profiles associated with the knowledge neighbor; and
calculating the affinity using the count of the knowledge profiles.

17. The method of claim 16, wherein calculating the affinity comprises:
factoring in a confidence level for the knowledge neighbor in each of the counted knowledge profiles.

18. The method of claim 1, wherein deriving the affinity comprises using a formula
$${\sum }_{P = 1}^{N} {L ( R )}_{P} * {L ( C )}_{P}$$
to calculate the affinity, wherein N is a count of the knowledge profiles associated with the knowledge neighbor, R is the root concept, C is the knowledge neighbor, L(R) is a confidence level for the root concept in a profile P, and L(C) is the confidence level of the knowledge neighbor in the profile P.

19. A computer-readable medium having computer-executable instructions comprising:
selecting a set of knowledge profiles associated with a root concept;
determining a knowledge neighbor for the root concept, the knowledge neighbor being a concept common to the selected knowledge profiles; and
deriving an affinity for the knowledge neighbor to represent a relationship between the root concept and the knowledge neighbor.

20. The computer-readable medium of claim 19 having further instructions comprising:
using the knowledge neighbor as a new root concept to determine an additional knowledge neighbor.

21. The computer-readable medium of claim 19 having further instructions comprising:
obtaining an identity for the root concept.

22. The computer-readable medium of claim 19 having further instructions comprising:
creating a knowledge map to graphically illustrate the root concept, the knowledge neighbor, and the affinity.

23. The computer-readable medium of claim 22 having further instructions comprising:
using the knowledge map to designate the knowledge neighbor as a new root concept to determine an additional knowledge neighbor.

24. The computer-readable medium of claim 22 having further instructions comprising:
overlaying the knowledge map on an earlier generated knowledge map for the root concept.

25. The computer-readable medium of claim 22 having further instructions comprising:
graphically illustrating more than one knowledge neighbor as a single knowledge neighbor.

26. A computer system comprising:
a processing unit;
a memory coupled to the processing unit through a bus;
a computer-readable medium coupled to the processing unit through the bus; and
a knowledge neighborhood generation process executed from the computer-readable medium to cause the processing unit to select a set of knowledge profiles associated with a root concept, determine a knowledge neighbor for the root concept from the selected knowledge profiles, and derive an affinity for the knowledge neighbor.

27. The computer system of claim 26, wherein the knowledge neighborhood generation process further causes the processing unit to use the knowledge neighbor as a new root concept to determine an additional knowledge neighbor.

28. The computer system of claim 26, wherein the knowledge neighborhood generation process further causes the processing unit to obtain an identity for the root concept.

29. The computer system of claim 26 further comprising:
a knowledge mapping process executed from the computer-readable medium to cause the processing unit to graphically illustrate the knowledge neighbor and the affinity as a knowledge neighborhood for the root concept.

30. The computer system of claim 29, wherein the knowledge mapping process further causes the processing unit to graphically overlay the knowledge neighborhood on an earlier generated knowledge neighborhood for the root concept.
